(19) United States
(12) Patent Application Publication
(10) Pub. No.: US 2022/0314719 A1
(43) Pub. Date: Oct. 6, 2022

(54) TRAILER ASSISTANCE SYSTEM WITH IMPROVED CONTACT DETECTION PERFORMANCE FROM VEHICLE START OR STANDSTILL

(71) Applicant: Ford Global Technologies, LLC, Dearborn, MI (US)

(72) Inventors: Chenhao Ma, Canton, MI (US); Li Xu, Bloomfield Hills, MI (US); Douglas Rogan, Mountain View, CA (US); Alexander Lee Hunton, Dearborn, MI (US); Luke Niewiadomski, Dearborn, MI (US)

(73) Assignee: Ford Global Technologies, LLC, Dearborn, MI (US)

(21) Appl. No.: 17/223,434

(22) Filed: Apr. 6, 2021

(51) Int. Cl. B60D 1/36; B60R 1/00; B60D 1/62

(52) U.S. Cl. CPC B60D 1/36; B60R 1/001; B60D 1/62; B60R 2300/808

(57) ABSTRACT

A system for a vehicle towing a trailer includes a sensor system configured to detect objects in an operating environment of the vehicle and a controller configured to monitor a relative position of at least one object with respect to the vehicle during an initial vehicle movement and store in memory the information as a reference data set at an instance when the initial vehicle movement ends at a vehicle standstill. The controller is further configured to retrieve from memory the reference data set upon detecting an event indicating an end of the vehicle standstill, process the reference data set to determine whether the at least one object is in a travel path of the trailer corresponding with a subsequent vehicle movement, and execute a contact avoidance measure based on the at least one object being in the travel path of the trailer.

### FIELD OF THE DISCLOSURE

The present disclosure generally relates to a driver assistance system for a vehicle. In particular, the system is configured to improve detection of a potential contact between a trailer towed by the vehicle and an object subsequent to certain vehicle standstill conditions.

### BACKGROUND OF THE DISCLOSURE

A trailer being towed by a vehicle does not follow the exact path of the vehicle as the vehicle turns. As such, towing a trailer around curves may be challenging for drivers. Further, some systems that may be used to determine the possibility of the trailer making contact with an object require that the vehicle move a certain distance or reach a certain speed for calibration before such a determination can be made or indicated to the driver.

### SUMMARY OF THE DISCLOSURE

According to one aspect of the present disclosure, a trailer flank object contact avoidance system for a vehicle towing a trailer including a sensor system configured to detect objects in an operating environment of the vehicle and a controller configured to process information received from the sensor system to monitor a relative position of at least one object with respect to the vehicle during an initial vehicle movement and store in memory the information received from the sensor system as a reference data set at an instance when the initial vehicle movement ends at a vehicle standstill. The controller is further configured to retrieve from memory the reference data set upon detecting an event indicating an end of the vehicle standstill relating to a subsequent vehicle movement, process the reference data set to determine whether the at least one object is in a travel path of the trailer corresponding with the subsequent vehicle movement, and execute a contact avoidance measure based on the at least one object being in the travel path of the trailer.

Embodiments of the first aspect of the invention can include any one or a combination of the following features:
the controller is further configured to determine that the standstill is associated with the vehicle parked and in an off condition and only retrieve from memory the reference data set and process the information received from the sensor system to determine whether the at least one object is in the travel path of the trailer if the event indicating the end of the vehicle standstill is detected at an elapsed time from the end of the initial vehicle movement being within a predetermined time interval;
the controller is further configured to communicate a feature unavailable status if the elapsed time exceeds the predetermined time interval;
the controller is further configured to determine that the standstill is associated with the vehicle being parked and in an off condition, detect a trailer movement event, and only retrieve from memory the reference data set and process the information received from the sensor system to determine whether the at least one object is in a travel path of the trailer if the event indicating the end of the vehicle standstill is detected within a predetermined time interval of the end of the initial vehicle movement and if the controller has not detected the trailer movement event;
the controller is further configured to detect a trailer electrical connection status with respect to a vehicle electrical connection and a trailer hitch angle with respect to the vehicle and to receive a trailer profile selection from a user, and the trailer movement event is detected by one of the trailer electrical connection status changing to a connected status the vehicle standstill, the trailer electrical connection status changing to a disconnected status during the vehicle standstill, the trailer hitch angle having different values at the end of the vehicle standstill and the end of the initial vehicle movement, or the controller receiving the trailer profile selection during the standstill;
the controller is further configured to communicate a feature unavailable status if either the event indicating the end of the vehicle standstill is detected outside of the predetermined time interval of the end of the initial vehicle movement or the trailer movement event is detected;
the sensor system includes an ultrasonic sensor, a radar unit, and a camera, the relative position of the at least one object being stored as combined data from the ultrasonic sensor, the radar unit, and the camera, and the controller is configured to process the reference data set retrieved from memory associated with the radar unit and the camera in combination with new information received from the ultrasonic sensor to determine whether the at least one object is in a travel path of the trailer corresponding with the subsequent vehicle movement;
the controller is further configured to detect at least one of a vehicle service brake position, a vehicle parking brake status, or a vehicle switchgear state, and the controller detects the event indicating the end of the vehicle standstill based on at least one of the vehicle service brake position indicating a release of the vehicle service brakes, the vehicle parking brake status indicating a release of the vehicle parking brake, or the vehicle switchgear state indicating shifting of the switchgear into a drive state or a reverse state;
the controller uses an assumed vehicle speed when processing the reference data set;
the reference data set includes the relative position of the at least one object and a localized vehicle position; and
the contact avoidance measure comprises at least one of reducing a manual steering torque assist supplied by a power assist steering system, executing an indication signal via a vehicle alert system, and causing a reduction in a speed of the vehicle.

According to another aspect of the present disclosure, a trailer flank object contact avoidance system for a vehicle towing a trailer including a sensor system configured to detect objects in an operating environment of the vehicle and a controller configured to process information received from the sensor system to monitor a relative position of at least one object with respect to the vehicle during an initial vehicle movement, determine when the initial vehicle movement ends at a vehicle standstill, and monitor for an event indicating an intent to launch the vehicle from the vehicle standstill. The controller is further configured to process the reference data set to determine whether the at least one object is in a travel path of the trailer corresponding with a subsequent vehicle movement resulting from the intent to launch the vehicle, and to execute a contact avoidance measure based on the at least one object being in the travel path of the trailer.

According to another aspect of the present disclosure, a trailer flank object contact avoidance system for a vehicle towing a trailer including a sensor system configured to detect objects in an operating environment of the vehicle and a controller configured to process information received from the sensor system to monitor a relative position of at least one object with respect to the vehicle during an initial vehicle movement and store in memory the information received from the sensor system as a reference data set at an instance when the initial vehicle movement ends at a vehicle standstill and to maintain the information in memory in response to the vehicle being turned off. The controller is further configured to retrieve from memory the reference data set upon the vehicle subsequently being turned on, process the reference data set, upon a subsequent vehicle movement, to determine whether the at least one object is in a travel path of the trailer corresponding with the subsequent vehicle movement, and to execute a contact avoidance measure based on the at least one object being in the travel path of the trailer.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a top perspective view of a vehicle attached to a trailer with a hitch angle sensor of a sensor system of the vehicle for operating a trailer contact avoidance system, according to one embodiment;

FIG. 2 is a block diagram illustrating the trailer contact avoidance system, having the sensor system, a controller, and various other vehicle systems, according to one embodiment;

FIG. 3 is a schematic diagram that illustrates the geometry of the vehicle, the trailer, and the object overlaid with a two dimensional x-y coordinate system, identifying variables and parameters used in operation of the trailer contact avoidance system, according to one embodiment;

FIG. 4 is a schematic diagram of the geometry of the vehicle, the trailer, and the object, illustrating a virtual circle intersecting an inner trailer boundary line, according to one embodiment;

FIG. 5 is an example of an indication presentable to a driver of the vehicle that the object is in the path of the trailer=;

FIG. 6 is a flow diagram illustrating a trailer contact avoidance routine, according to one embodiment;

FIG. 7 is a flow diagram illustrating a sub-process for determining that an environment model can be carried over after the vehicle is turned off and subsequently turned on; and

FIG. 8 is a flow diagram illustrating a sub-process for determining if the object is in the path of the trailer upon the system detecting an intent to launch the vehicle from a standstill.

### DETAILED DESCRIPTION OF THE PREFERRED EMBODIMENTS

Additional features and advantages of the invention will be set forth in the detailed description which follows and will be apparent to those skilled in the art from the description, or recognized by practicing the invention as described in the following description, together with the claims and appended drawings.

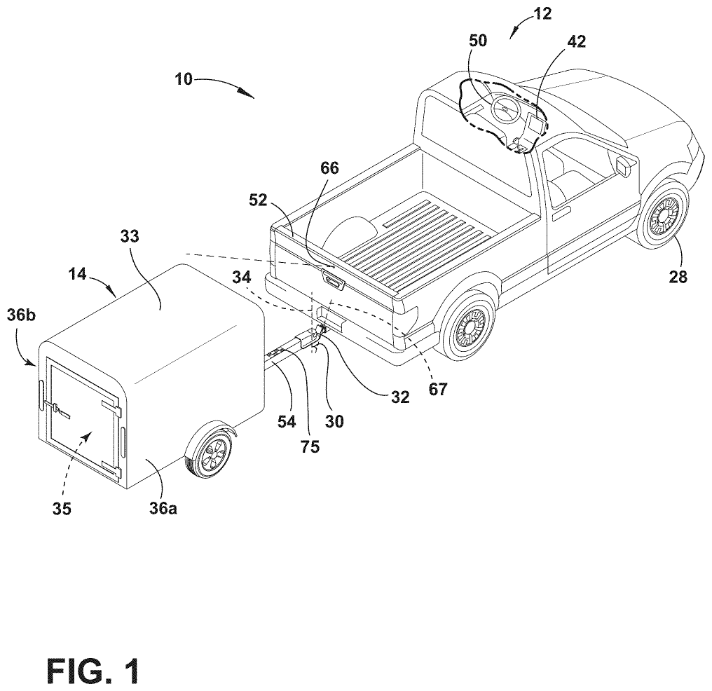

For purposes of description herein, the terms “upper,” “lower,” “right,” “left,” “rear,” “front,” “vertical,” “horizontal,” “interior,” “exterior,” and derivatives thereof shall relate to the device as oriented in FIG. 1. However, it is to be understood that the device may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, reference numeral 10 generally designates a trailer flank object contact avoidance system for a vehicle 12 towing a trailer 14. The system 10 includes a sensor system 16 configured to detect objects O in an operating environment E of the vehicle 12 and a controller 26. The controller 26 is configured to process information (e.g. in the form of sensor data 18) received from the sensor system 16 to monitor a relative position (X_{O}, Y_{O}) of at least one object O with respect to the vehicle 12 during an initial vehicle movement and store in memory 10 the information 18 received from the sensor system 16 as a reference data set at an instance when the initial vehicle movement ends at a vehicle standstill. The controller 26 is also configured to retrieve from memory 70 the reference data set upon detecting an event indicating an end of the vehicle standstill relating to a subsequent vehicle movement, to process the reference data set to determine whether the at least one object O is in a travel path 20 of the trailer 14 corresponding with the subsequent vehicle movement, and to execute a contact avoidance measure based on a determination that the at least one object O is in the travel path 20 of the trailer 14.

With reference to the embodiment shown in FIG. 1, the vehicle 12 is a pickup truck embodiment that is equipped with one embodiment of the trailer contact avoidance system 10 for monitoring and/or controlling the path of the trailer 14 that is attached to the vehicle 12. Specifically, the vehicle 12 is pivotally attached to one embodiment of the trailer 14 that has a box frame 33 with an enclosed cargo area 35 and a tongue 54 longitudinally extending forward from the enclosed cargo area 35. The illustrated trailer 14 defines opposite right and left flanks 36a and 36b on portions of the depicted box frame 34, with other trailers similarly defining flanks on other portions or features thereof. In general, the trailer flanks 36a and 36b may be defined as the outermost portions of the trailer 14 or the point at which an object O in the vicinity of trailer 14 would make contact with trailer 14 from a lateral position. The illustrated trailer 14 also has a trailer hitch connector in the form of a coupler assembly 32 that is connected to a vehicle hitch connector in the form of a hitch ball 30. The coupler assembly 32 latches onto the hitch ball 30 to provide a pivoting ball joint connection about coupling point 34 that allows for articulation of the hitch angle γ. It should be appreciated that additional embodiments of the trailer 14 may include more than one axle; may have various shapes and sizes configured for different loads and items, such as a boat trailer or a flatbed trailer; and may alternatively couple with the vehicle 12 to provide a pivoting connection, such as by connecting with a fifth wheel connector.

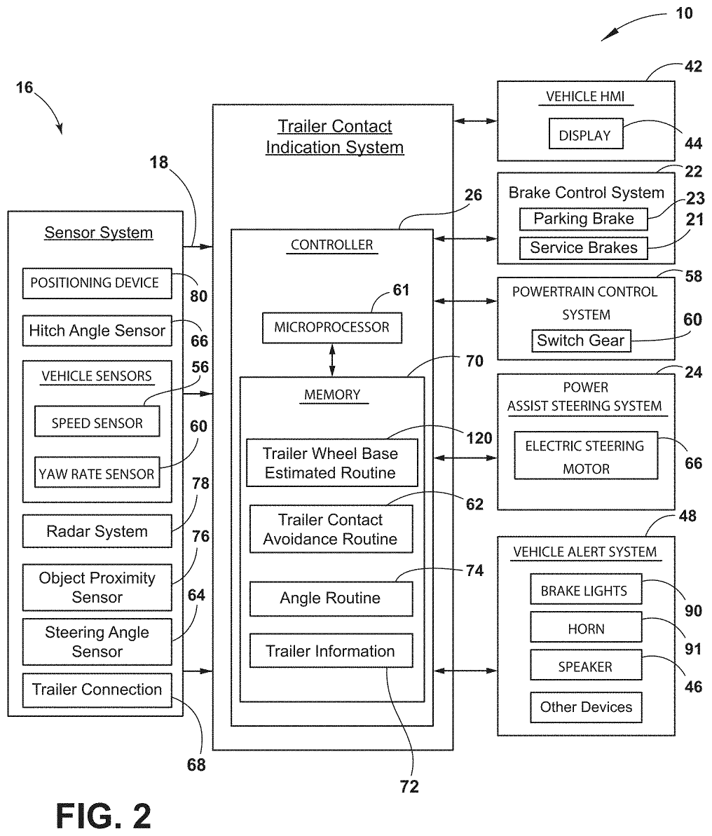

Referring now to FIG. 2, the vehicle 12 may include a sensor system 16 having a plurality of sensors configured to detect objects O in the operating environment E of the vehicle 12 that may be in a potential travel path 20 of the trailer 14. The plurality of sensors may include one or a combination of visual sensors (e.g., cameras 66, surround view cameras, etc.), radar sensors 78, Lidar sensors, ultrasonic sensors 76, lasers, thermal sensors, and/or various other sensors. For example, in some embodiments, the vehicle 12 may include ultrasonic sensors 76, surround view cameras, radar sensors 78 disposed on the corners and front of the vehicle 12, and a camera 66 on the front of the vehicle 12. It is contemplated that the plurality of sensors in the sensor system 16 may be located in various positions on the vehicle 12. It is further contemplated that, in some embodiments, one or more of the plurality of sensors may be coupled to the trailer 14 in addition to the one or more sensors coupled to the vehicle 12. The sensor system 16 may be configured to provide sensed inputs to the controller 26. In various embodiments, the data collected from the plurality of sensors in the sensor system 16 may be utilized by the controller 26 to map the features detected within the operating environment E of the vehicle 12. The features detected within the operating environment E of the vehicle 12 may include, but are not limited to, the vehicle 12, the trailer 14, and objects O, such as moving and stationary objects O within a prescribed distance of the vehicle 12 and/or the trailer 14.

In one example, the data collected from the variety of sensor types (e.g., visual, radar, ultrasonic) may be fused (sensor fusion) to simulate virtual sensors positioned on the vehicle 12. The result of the fusion may function as virtual sensor system and may be configured to output a spatial segmentation of the operating environment E of the vehicle 12. In some embodiments, the spatial segmentation of the operating environment E of the vehicle 12 may be output as a two dimensional representation of the operating environment E of the vehicle 12 from a top-down perspective with objects O detected by the virtual sensor system within the operating environment E of the vehicle 12 may be represented by a distance from the detected object O to a delineated vehicle boundary. In some embodiments, the detected object O may further be represented by the object's 15 determined position within a 2D world coordinate frame of the operating environment E of the vehicle 12. In various embodiments, the delineated vehicle boundary 22 may generally trace the contour of the exterior of the vehicle 12 from a top-down perspective. Various ways in which the trailer contact avoidance system can use the virtual sensor system 18 to identify and characterize objects O within the operating environment E of the vehicle 12 are described further in co-pending, commonly assigned U.S. patent application Ser. No. 16/564,351 (“the '351 Application”), the entire contents of which are incorporated by reference herein. In particular, the virtual sensor system may provide information to the trailer contact avoidance system 10 regarding trailer width Tw, and/or hitch angle γ of the trailer 14 being towed by the vehicle 12, as well as the delineated vehicle boundary 22 of the vehicle 12, and moving or stationary objects O within the operating environment E of the vehicle 12, including with reference to the vehicle position. It is contemplated that various other sensor systems and/or methods for processing the information from such systems to determine the locations of objects O with respect to the vehicle 12 can be used within the system 10 as described further herein.

As discussed further below, various aspects of the system 10 use a measurement for the above-described hitch angle γ. In at least one aspect, the hitch angle γ, as shown in FIG. 1, may be determined using a vision based hitch angle sensor routine 74 that further leverages at least some components of sensor system 16. In an example, the hitch angle routine 74 may employ camera 66 (e.g. video imaging camera) that may be located proximate an upper region of the vehicle tailgate 52 at the rear of the vehicle 12, such that the camera 66 may be elevated relative to the tongue 54 of the trailer 14. The camera 66 may include an imaging field of view 67 located and oriented to capture one or more images of the trailer 14, including a region containing one or more desired target placement zones for at least one target 75 to be secured. It is contemplated that the camera 66 may capture images of the trailer 14 without a target 75 to determine the hitch angle γ. However, the trailer contact avoidance system 10 may utilize one or more targets 75 placed on the trailer 14 to allow the trailer contact avoidance system 10 to utilize information acquired via image acquisition and processing of the target 52. For instance, the camera 66 may include a video imaging camera that repeatedly captures successive images of the trailer 14 that may be processed to identify the target 52 and its location on the trailer 14 for determining movement of the target 52 and the trailer 14 relative to the vehicle 12 and the corresponding hitch angle γ. It should also be appreciated that the camera 66 may include one or more video imaging cameras and may be located at other locations on the vehicle 12 to acquire images of the trailer 14 and the desired target placement zone, such as on a passenger cab of the vehicle 12 to capture images of a gooseneck trailer. Furthermore, it is contemplated that additional embodiments of the hitch angle routine 74 and the sensor system 16 for providing the hitch angle γ may include one or a combination of a potentiometer, a magnetic-based sensor, an optical sensor, a proximity sensor, a rotational sensor, a capacitive sensor, an inductive sensor, or a mechanical based sensor, such as a mechanical sensor assembly mounted to the pivoting ball joint connection 34, a yaw rate sensor on the trailer 14 and the vehicle 12, energy transducers of a reverse aid system, a blind spot system, and/or a cross traffic alert system, and other conceivable sensors or indicators of the hitch angle γ to supplement or be used in place of the vision based hitch angle routine 74.

Further, with respect to determining the position of the vehicle 12, in some embodiments, the trailer contact avoidance system 10 may receive vehicle status-related information from additional sensors and devices. This information may include positioning information from a positioning system 80, which may include a global positioning system (GPS) on the vehicle 12 or a handled device, to determine a coordinate location of the vehicle 12 and the trailer 14 based on the location of the positioning system 80 with respect to the trailer 14 and/or the vehicle 12 and based on the sensed hitch angle γ. The positioning system 80 may additionally or alternatively include a dead reckoning system for determining the coordinate location of the vehicle 12 and the trailer 14 within a localized coordinate system based at least on vehicle speed v₁, steering angle δ, and hitch angle γ. Other vehicle information received by the trailer contact avoidance system 10 may include a speed v₁ of the vehicle 12 from a speed sensor 56 and a yaw rate Wi of the vehicle 12 from the yaw sensor 60.

Further still, with respect to detecting potential obstacles, in some embodiments, the sensor system 16 of the trailer contact avoidance system 10 may include an object proximity sensor 76 that provides the proximity of an object O to the controller 26 of the trailer contact avoidance system 10. More specifically, the object proximity sensor 76 may provide the trailer contact avoidance system 10 with proximity information of the object O, which may include information estimating a location of the object O or objects O relative to the vehicle 12 and/or trailer 14. The object proximity sensor 76 may include an individual sensor, multiple sensors, and various combinations of sensors and sensor systems to capture, generate, and output information characterizing the proximity of the object O adjacent to the vehicle 12 and/or trailer 14, as described in more detail herein. Accordingly, the object proximity sensor 76 may include portions of or be incorporated with the hitch angle sensor 44, the positioning device 56, or other additional sensors and devices. The trailer contact avoidance system 10 may use the proximity information of the object O or objects O as an input to the controller 26 to make the driver aware of or avoid any contact between the trailer 14 and the object O or objects O, as disclosed in greater detail below.

Referring now to FIG. 2, in some embodiments, the trailer contact avoidance system 10 is in communication with a power assist steering system 24 of the vehicle 12 to operate the steered wheels 28 (FIG. 1) of the vehicle 12 for moving the vehicle 12 in such a manner that the trailer 14 reacts in accordance with the desired path of the trailer 14. In some embodiments, the power assist steering system 24 may be an electric power-assisted steering (EPAS) system that includes an electric steering motor 25 for turning the steered wheels 28 to a steering angle δ based on a steering command, whereby the steering angle δ may be sensed by a steering angle sensor 64 of the power assist steering system 24. The steering command may be provided by the trailer contact avoidance system 10 for autonomously steering or inhibiting manual steering during a potential trailer contact event and may alternatively be provided manually via a rotational position (e.g., steering wheel angle) of a steering wheel 50 (FIG. 1).

Referring further to FIG. 2, the power assist steering system 24 provides the controller 26 of the trailer contact avoidance system 10 with information relating to a rotational position of steered wheels 28 of the vehicle 12, including the steering angle S. In some embodiments, the controller 26 may process the current steering angle δ, in addition to other vehicle 12 and trailer 14 conditions, to tow the trailer 14 along a desired path. It is conceivable that the trailer contact avoidance system 10, in additional embodiments, may be an integrated component of the power assist steering system 24. In further reference to FIG. 2, the vehicle brake control system 22 may also communicate with the controller 26 to provide the trailer contact avoidance system 10 with braking information, such as vehicle wheel speed, and to receive braking commands from the controller 26. For instance, vehicle speed information can be determined from individual wheel speeds as monitored by the brake control system 22. Vehicle speed v₁ may also be determined from the powertrain control system 58, the speed sensor 56, and the positioning system 80, among other conceivable means. In some embodiments, individual wheel speeds can also be used to determine a vehicle yaw rate Wi, which can be provided to the trailer contact avoidance system 10 in the alternative or in addition to the vehicle yaw rate sensor 60. In certain embodiments, the trailer contact avoidance system 10 can provide vehicle braking information to the brake control system 22 for allowing the trailer contact avoidance system 10 to control braking of the vehicle 12 during towing of the trailer 14. For example, the trailer contact avoidance system 10 in some embodiments may regulate speed of the vehicle 12 while maneuvering the trailer 14 around turns or when objects O are detected, which can reduce the potential for contact events, as will be further discussed below. The powertrain control system 58, as shown in the embodiment illustrated in FIG. 2, may also interact with the trailer contact avoidance system 10 for regulating speed and acceleration of the vehicle 12 during towing of the trailer 14. As mentioned above, regulation of the speed of the vehicle 12 may be necessary to limit the potential for contact events. Similar to high-speed considerations as they relate to the potential of a contact event, high acceleration and sharp turns by the driver may also lead to potential contact events.

With continued reference to FIG. 2, the trailer contact avoidance system 10 in the illustrated embodiment may communicate with one or more devices, including a vehicle alert system 48, which may prompt visual, auditory, and/or tactile indication signals. For instance, vehicle brake lights 90 and vehicle emergency flashers may provide a visual alert and a vehicle horn 91 and/or speaker 92 may provide an audible alert. Additionally, the trailer contact avoidance system 10 and/or vehicle alert system 48 may communicate with a human machine interface (HMI) 42 for the vehicle 12. The HMI 42 may include a vehicle display 44, such as a center-stack mounted navigation or entertainment display (FIG. 1). Further, the trailer contact avoidance system 10 may communicate via wireless communication with another embodiment of the HMI 42, such as with one or more handheld or portable devices, including one or more smartphones. The portable device may also include the display 44 for displaying one or more images and other information to a user. In addition, the portable device may provide feedback information, such as indication signals that are visual, audible, tactile, and/or a combination thereof.

As further illustrated in FIG. 2, the controller 26 is configured with a microprocessor 61 to process logic and routines stored in memory 70 that receive information from the sensor system 16, the power assist steering system 24, the vehicle brake control system 22, the trailer braking system, the vehicle alert system 48, the powertrain control system 58, and other vehicle sensors and devices. The controller 26 may generate indications, as well as vehicle steering information and commands as a function of all or a portion of the information received. Thereafter, the vehicle steering information and commands may be provided to the power assist steering system 24 for affecting steering of the vehicle 12 to avoid a path of travel leading to a contact event, inhibit manual steering into a path of travel leading to a contact event, and/or modify a path of travel to prevent an imminent contact event of the trailer 14. Additionally, the controller 26 may be configured to prompt one or more vehicle systems (e.g., vehicle alert system 48, vehicle brake control system 22, etc.) to execute one or more contact avoidance measures, as will be discussed in more detail in paragraphs below.

The controller 26 may include the microprocessor 61 and/or other analog and/or digital circuitry for processing one or more routines. Also, the controller 26 may include the memory 70 for storing one or more routines, including a trailer wheel base estimation routine 120, a trailer contact avoidance routine 62, and a desired steering wheel angle routine 74. It should be appreciated that the controller 26 may be a stand-alone dedicated controller or may be a shared controller integrated with other control functions, such as integrated with the sensor system 16, the power assist steering system 24, and other conceivable onboard or off-board vehicle control systems.

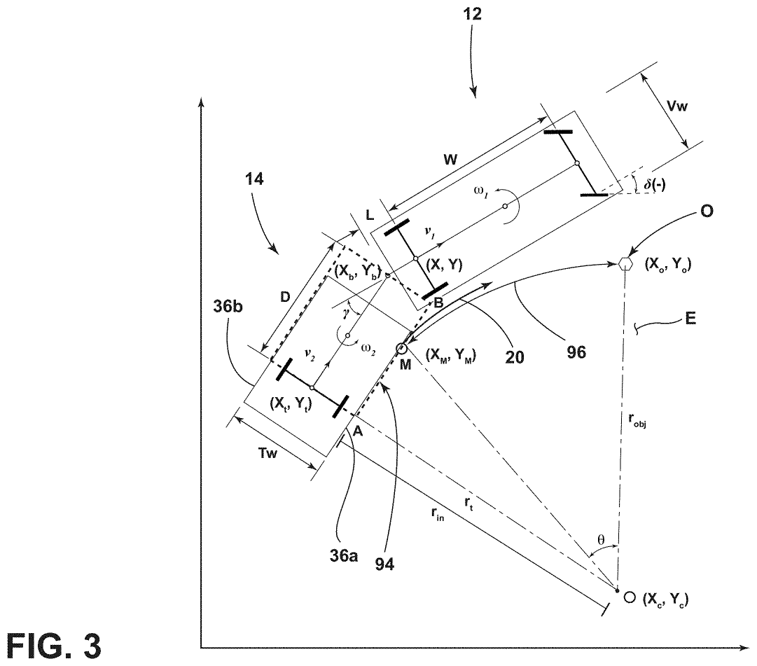

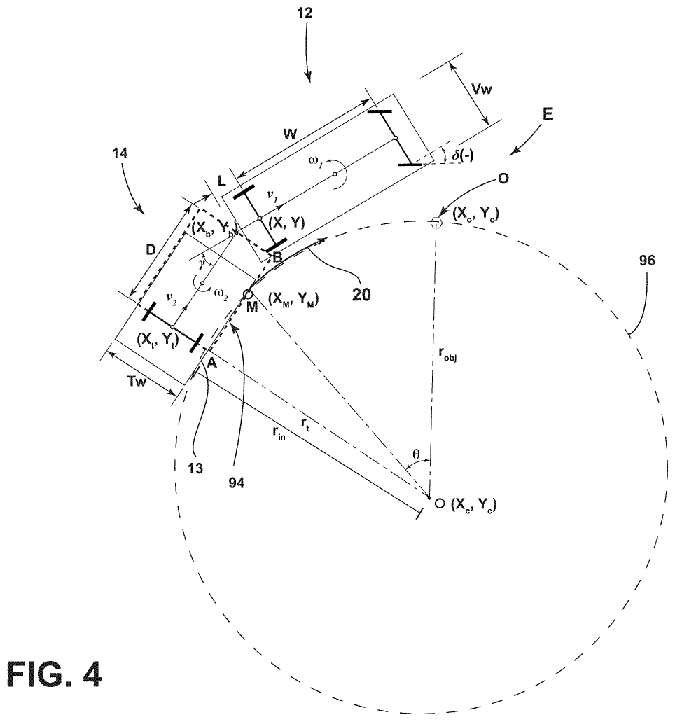

With reference to FIGS. 3 and 4, we now turn to a discussion of vehicle 12 and trailer 14 information and parameters used to determine a kinematic relationship between the vehicle 12 and the trailer 14 for use in the trailer contact avoidance routine 62. This kinematic relationship may be useful in determining what the travel path of the trailer 14 may be and whether the travel path coincides with objects O within the operating environment E of the vehicle 12, such that a contact event would result. In describing the kinematic relationship, certain assumptions may be made with regard to parameters associated with the vehicle 12 and/or the trailer 14. Examples of such assumptions include, but are not limited to, the wheels of the vehicle 12 and the trailer 14 having negligible (e.g., no) slip, tires of the vehicle 12 having negligible (e.g., no) lateral compliance, tires of the vehicle 12 and the trailer 14 having negligible (e.g., no) deformation, actuator dynamics of the vehicle 12 being negligible, and the vehicle 12 and the trailer 14 exhibiting negligible (e.g., no) roll or pitch motions, among other conceivable factors with the potential to have an effect on controlling the trailer 14 with the vehicle 12.

As shown in FIG. 3, for a system defined by the combination of the vehicle 12 and the towed trailer 14, the kinematic relationship is based on various parameters associated with the vehicle 12 and the trailer 14. These parameters may include:
δ: steering angle at steered front wheels 28 of the vehicle 12;
α: yaw angle of the vehicle 12;
β: yaw angle of the trailer 14;
γ: hitch angle (γ=β−α);
W: wheel base of the vehicle 12;
L: length between hitch point and rear axle of the vehicle 12;
D: trailer wheel base, i.e. distance between hitch point and axle of the trailer 14 or effective axle for a multiple axle trailer 14 (axle length may be an equivalent);
rₜ: dynamic turning radius of the trailer 14;
V_{w}: width of the vehicle 12;
T_{w}: width of the trailer 14;
v₁: vehicle speed;
v₂: trailer speed;
ω₁: vehicle yaw rate; and
ω₂: trailer yaw rate.

It is contemplated that there may be various parameters utilized in determining the kinematic relationship between the vehicle 12 and the trailer 14 that are generally fixed and correspond to the dimensions of the vehicle 12 and trailer 14 combination. Specifically, the trailer wheel base D, the wheel base W of the vehicle 12, and the length L between the hitch point and the rear axle of the vehicle 12 may be generally fixed and may be stored in memory 70, whereas other parameters may be dynamic and obtained from the sensor system 16 on an ongoing basis. It is noted that the wheel base W of the vehicle 12 and the length L between the hitch point and the rear axle of the vehicle 12 relate only to the vehicle 12 itself, within which the controller 26 and, accordingly, memory 70 are installed. It follows, then, that these parameters may be stored in memory 70 during manufacture of vehicle 12, or during installation of the relevant portions of the vehicle 12, as they are known in relation to the specific make and model of the particular vehicle 12.

In some embodiments, an assumption may be made by the trailer contact avoidance system 10 that the length L between the hitch point and the rear axle of the vehicle 12 is equal to zero for purposes of operating the trailer contact avoidance system 10 when a gooseneck trailer or other similar trailer 14 is connected with the hitch ball or a fifth wheel connector located over the rear axle of the vehicle 12. Such an embodiment assumes that the pivoting connection with the trailer 14 is substantially vertically aligned with the rear axle of the vehicle 12. Further, the controller 26 may be configured with modified algorithms to account for this assumption in operation of the trailer contact avoidance system 10. It is appreciated that the gooseneck trailer mentioned generally refers to the tongue configuration being elevated to attach with the vehicle 12 at an elevated location over the rear axle, such as within a bed of a truck, whereby embodiments of the gooseneck trailer may include flatbed cargo areas, enclosed cargo areas, campers, cattle trailers, horse trailers, lowboy trailers, and other conceivable trailers with such a tongue configuration.

Contrary to fixed vehicle parameters (e.g., L, W), the trailer wheel base D, while fixed with respect to a given trailer 14 that is coupled to the vehicle 12, may vary as different trailers 12 are hitched to vehicle 12 for towing thereby. Further, the particular trailer 14 with which a given vehicle 12 will be used may not be known during manufacture of vehicle 12, and a user of such vehicle 12 may wish to use the vehicle 12 with various trailers 12 of different sizes and configurations. Accordingly, a routine or other method for the trailer contact avoidance system 10 to obtain the particular trailer wheel base D may be needed and, in some embodiments, may be required for the trailer contact avoidance system 10 to operate.

In some embodiments, a short-range radar module may be included in the sensor system 16 of the vehicle 12. Such short-range radar may be electrically coupled with and used by controller 26 to locate one or more “corner cubes” that can be strategically placed on trailer 14 in relation to (e.g. directly above) the front axle thereof. Corner cubes are generally known and are accepted as reliable reflectors of radar and can be used reliably for distance measurements. In an example, corner cubes with magnetic bases can be provided with vehicle 12 for mounting on the particular trailer 14 installed with vehicle 12 at a given time. Further, by using a triangulation method, two corner cubes placed on opposite sides of trailer 14 may also be used to determine the hitch angle γ.

In some embodiments, controller 26 may implement a trailer wheel base estimation routine 120 as-needed to determine the trailer wheel base D within a desired degree of accuracy. In particular, the trailer wheel base estimation routine 120 may utilize an estimate of hitch angle γ determined by the trailer contact avoidance system 10 to derive an estimate for trailer wheel base D. A number of trailer wheel base estimates, taken at regular time intervals over one or more identified periods in which conditions allow for such estimates, can be averaged or filtered to produce a final weighted estimate of trailer wheel base D. Such routines may be generally known in the art.

By utilizing these parameters, as well as the other parameters listed above for a variety of calculations, the kinematic relationship between the vehicle 12 and the trailer 14 can be deduced, and whether the towed trailer 14 may contact the object O detected in the operating environment E of the vehicle 12 may be determined, as described below.

Initially, a position of the hitch ball 30 (x_{b}, y_{b}) may be determined based on the position of the vehicle 12 (x, y), the vehicle yaw angle α, and the length L between the hitch point and rear axle of the vehicle 12. This hitch ball 30 location (x_{b}, y_{b}) is given by the following equations:

x_{b}=x−L cos α (1)

y_{b}=y−L sin α (2)

In various embodiments, the position of the vehicle 12 (x, y) may be represented by a point where a line running along a rear axle of the vehicle 12 intersects a longitudinal centerline of the vehicle 12, as shown in FIGS. 3 and 4.

The trailer yaw angle β may be determined by utilizing the above-mentioned vehicle yaw angle α and the determined hitch angle γ, via the following equation:

β=γ+α (3)

The trailer yaw rate ω₂ may be determined with the hitch angle γ, the trailer wheel base D, the vehicle speed v₁, and the vehicle yaw rate ω₁, via the following equation:

$${ω}_{2} = - \frac{{v}_{1}}{D} sin γ - \frac{L}{D} cos {γω}_{1} \qquad ( 4 )$$

The trailer speed v₂ may be determined with the length L between the hitch point and the rear axle of the vehicle 12, the vehicle yaw rate (Di, the vehicle speed v₁, and the hitch angle γ, via the following equation:

v₂=v₁ cos γ−L sin ω₁ (5)

Next, the dynamic trailer turning radius rₜ may be determined by dividing the determined trailer speed v₂ by the trailer yaw rate ω₂:

$${r}_{t} = \frac{{v}_{2}}{{ω}_{2}} \qquad ( 6 )$$

For the purposes of operating the trailer contact avoidance system 10, the dynamic trailer turning radius rₜ may be limited to maximum value Rₘₐₓ such that:

−Rₘₐₓ≤rₜ≤Rₘₐₓ (7)

The position of the trailer (xₜ, yₜ) may be determined by using the hitch ball 40 location calculated above (x_{b}, y_{b}), the trailer wheel base D, and the trailer yaw angle β, via the following equations:

xₜ=x_{b}−D cos β

yₜ=y_{b}−D sin β (8)

Next, the coordinates of the trailer turn center O (x_{c}, y_{c}) may be determined with the determined position of the trailer (xₜ, yₜ), the dynamic trailer turning radius rₜ, and the trailer yaw angle β, via the following equations:

x_{c}=xₜ−rₜ sin β

y_{c}=yₜ+rₜ cos β (9)

Having calculated the trailer turning center O, the distance r_{obj} of an object O from the trailer turning center O may be determined with the steering angle δ at the steered front wheels 64 of the vehicle 12, the coordinates of the trailer turn center O (x_{c}, y_{c}), and the position of the object O (x_{obj}, y_{obj}), via the following equation:

r_{obj}=sign(δ)\sqrt{(x_{c}−x_{obj})²+(y_{c}−y_{obj})²} (10)

As discussed above, the position of the object O (x_{obj}, y_{obj}) may be determined by the virtual sensor system 18 or through the use of a variety of other sensors and devices contemplated within the sensor system 16 of the present disclosure. Further, as discussed above, the steering angle δ may be based on data collected from the steering angle sensor 67.

Next, the trailer contact avoidance system 10 may determine whether the detected object O is in the path 20 of the trailer 14 relative to the trailer turning center O. Referring now to FIG. 4, the contact avoidance system 10 may utilize an inner trailer boundary line 94 extending between point A and point B (and corresponding with the one of flanks 36a or 36b toward the direction of steering angle δ), where point A is an intersection between an inner side 13 of the trailer 14 and a line extending outward along the axis of a trailer axle, and point B is a point displaced from point A by a distance equal to the length of trailer wheel base D in the trailer forward direction substantially parallel to a longitudinal centerline of the trailer 14. The inner side 13 of the trailer 14 may be the side of the trailer 14 that is generally facing the trailer turning center O. Accordingly, the inner side 13 of the trailer 14 may correspond with the turning direction of the vehicle 12. For example, the inner side 13 of the trailer 14 may be the left side of the trailer 14 when the vehicle 12 is turning left, while the inner side 13 of the trailer 14 may be the right side of the trailer 14 when the vehicle 12 is turning right, as illustrated in FIG. 4. The location of point A (x_{A}, y_{A}) may be determined with the position of the trailer (xₜ, yₜ), the trailer yaw rate ω₂, the trailer width Tw, and the trailer yaw angle β, via the following equations:

$${x}_{A} = {x}_{t} - sign ( {ω}_{2} ) \frac{Tw}{2} sin β \\ {y}_{A} = {y}_{t} + sign ( {ω}_{2} ) \frac{Tw}{2} cos β \qquad ( 11 )$$

The location of point B (x_{B}, y_{B}) may be determined with the position of the trailer (xₜ, yₜ), the trailer yaw rate ω₂, the trailer width Tw, the trailer yaw angle β, and the trailer wheel base D, via the following equations:

$${x}_{B} = {x}_{t} + D cos β - sign ( {ω}_{2} ) \frac{Tw}{2} sin β \\ {y}_{A} = {y}_{t} + D cos β + sign ( {ω}_{2} ) \frac{Tw}{2} cos β \qquad ( 12 )$$

Referring further to FIG. 4, having determined the coordinates of point A and point B, the trailer contact avoidance system 10 next determines whether the inner trailer boundary line 94 extending between point A and point B intersects a virtual circle 96 having a radius of r_{obj} (the distance of the detected object O from the trailer turning center O) and a center (x_{c}, y_{c}) (the coordinates of the trailer turn center O). If the inner trailer boundary line 94 is found to intersect the virtual circle 96, the trailer contact avoidance system 10 determines that the object O is in the travel path 20 of the trailer 14, such that a contact event may occur.

When the trailer contact avoidance system 10 determines that the inner trailer boundary line 94 intersects the virtual circle 96, such that the object O is in the travel path 20 of the trailer 14, the trailer contact avoidance system 10 may further determine the intersection point M (x_{M}, y_{M}) of the inner trailer boundary line 94 and the virtual circle 96. The intersection point M (x_{M}, y_{M}) may be determined with the following:

Defining:

$$dx = xB - xA \qquad ( 13 )$$

$$dy = yB - yA \qquad ( 14 )$$

$${d}_{r} = \sqrt{{d}_{x}^{2} + {d}_{y}^{2}} \qquad ( 15 )$$

$$Q = \vert \begin{matrix}xA & xB \\ yA & yB\end{matrix} \vert = xAyB - xByA ; \qquad ( 16 )$$

gives the intersection point M (xM, yM):

$${x}_{M} = \frac{{Qd}_{y} \pm sgn * ( {d}_{y} ) {d}_{x} \sqrt{{r}_{odj}^{2} {d}_{r}^{2} - {Q}^{2}}}{{d}_{r}^{2}} \qquad ( 17 )$$

$${y}_{M} = \frac{- {Qd}_{x} \pm \vert {d}_{y} \vert \sqrt{{r}_{obj}^{2} {d}_{r}^{2} - {Q}^{2}}}{{d}_{r}^{2}} . \qquad ( 18 )$$

Where the function sgn*(x) is defined as:

$${sgn}^{*} ( x ) ≡ \{ \begin{matrix}- 1 & for x < 0 \\ 1 & otherwise .\end{matrix} \qquad ( 19 )$$

With the calculated intersection point M (x_{M}, y_{M}) the angle θ between lines running from the trailer turn center O (x_{c}, y_{c}) to the intersection point M (x_{M}, y_{M}) and the trailer turn center O (x_{c}, y_{c}) to the position of the object O (x_{obj}, y_{obj}) may be determined using the law of cosines. The angle θ may then be used in conjunction with the dynamic trailer turning radius rₜ and the trailer speed v₂ to determine the time until contact tc of the object O with the trailer 14, via the following equation:

$${t}_{zz} = \frac{θ {r}_{t}}{{v}_{z}} . \qquad ( 20 )$$

Referring back to FIG. 2, in various embodiments, the controller 26 of the trailer contact avoidance system 10 may prompt one or more vehicle systems to execute a contact avoidance measure when the object O is determined to be in the travel path of the trailer 14. For example, in some embodiments, the controller 26 may prompt the vehicle alert system 48 to execute an indication signal to inform the driver of the vehicle 12 or others that the object O is in the travel path of the trailer 14. It is contemplated that the indication signal may be at least one of a variety of types of indication signals that may include, but is not limited to, visual indications, auditory indications, tactile indications, and/or a combination thereof. In some embodiments, the controller 26 may prompt the power assist steering system 24 to reduce the manual steering torque assist when the object O is determined to be in the travel path of the trailer 14.

For example, in some embodiments, when the object O is determined to be in the travel path of the vehicle 12 as the vehicle 12 is turning to the right, the power assist steering system 62 may reduce the manual steering torque assist provided for steering actions by the driver that would further turn the vehicle 12 to the right. As such, the power assist steering system 24 may be configured to inhibit manual steering by a driver that would result in a contact event happening more quickly or to a higher degree. It is contemplated that, in some embodiments, the controller 26 may prompt the power assist steering system 24 to reduce the manual steering torque assist supplied when the object O is not in the travel path of the trailer 14. For example, the controller 26 may prompt the power assist steering system 24 to reduce the manual steering torque assist supplied when over-steering the vehicle 12 would result in the travel path of the vehicle 12 intersecting with the object O. In this way, a contact avoidance measure may be employed preemptively to ensure that the trailer 14 does not come into contact with the object O. It is contemplated that, in some embodiments, the manual steering torque assist of the power assist steering system 24 may be utilized affirmatively to prevent the driver from turning in a given direction. An example process that can be implemented by controller 26 to achieve such a reduction in manual steering torque assist provided by the steering system 24 is described in the above-mentioned '351 Application.

In some applications, the controller 26 may prompt the vehicle brake control system 22 and/or the powertrain control system 58 to adjust the speed of the vehicle 12 when the object O detected in the operating environment E of the vehicle 12 is determined to be in the travel path of the trailer 14. For example, in some embodiments, the controller 26 may prompt the powertrain control system 58 and the vehicle brake control system 22 to work in unison to reduce the speed of the vehicle 12. It is contemplated that, in some embodiments, the controller 26 may prompt execution of a contact avoidance measure that stops the vehicle 12.

In some applications, the controller 26 may prompt various vehicle systems (e.g., the power assist steering system 24, the vehicle brake control system 22, the powertrain control system 58, etc.) to control movement of the vehicle 12 such that the predicted contact event is avoided or mitigated. For example, in some embodiments, the controller 26 may prompt the vehicle systems to reduce the steering angle δ of the vehicle 12 such that dynamic turning radius of the vehicle 12 and/or the dynamic trailer turning radius rₜ increases. The controller 26 may direct the vehicle systems to reduce the steering angle δ such that the travel path of the trailer 14 no longer overlaps with the position of the object O. For example, in some embodiments, the controller 26 may direct the vehicle systems to reduce the steering angle δ of the vehicle 12 such that the inner trailer boundary line 94 no longer intersects the virtual circle 96.

Referring now to FIG. 2, the controller 26 of the trailer contact avoidance system 10 may prompt one or more vehicle systems to execute a contact avoidance measure based on time until contact t_{c}. In some embodiments, a contact avoidance measure may be executed when the time until contact t_{c} is less than a threshold time value. In various embodiments, the threshold time value may be a predetermined value. In some examples, the threshold time value may be a fixed predetermined value that is stored in memory 70. Further, in some examples, the threshold time value may vary based on certain conditions in accordance with predetermined logic of the controller 26. For example, in some embodiments, the threshold time value may depend on at least one of a variety of conditions that may include, but is not limited to, vehicle speed v₁, trailer 14 dimensions, steering angle δ, size of detected object O, object O type classifications, and/or a combination thereof.

Referring further to FIG. 2, in some embodiments, the controller 26 of the trailer contact avoidance system 10 may prompt one or more vehicle systems to execute a first contact avoidance measure when the time until contact t_{c} is less than a first predetermined threshold time value and prompt one or more vehicle systems to execute a second contact avoidance measure when the time until contact t_{c} is less than a second predetermined threshold time value, wherein the first predetermined threshold time value is greater than the second predetermined threshold time value. For example, in some embodiments, the controller 26 of the trailer contact avoidance system 10 may prompt the vehicle alert system 48 to execute an indication signal when the time until contact t_{c} is less than 3 seconds and prompt the power assist steering system 24 to adjust the steering wheel angle when the time until contact t_{c} is less than 1.5 seconds. It is contemplated that, in some embodiments, the controller 26 of the trailer contact avoidance system 10 may prompt one or more vehicle systems to execute a plurality of contact avoidance measures based on the time until contact t_{c} coinciding with a plurality of threshold time values.

Additionally, the trailer contact avoidance system 10 can be configured to allow system functionality, as generally discussed above, when vehicle 12 begins moving from a standstill. Many of the components used by sensor system 16 require some degree of vehicle 12 movement for calibration and/or to establish a baseline data set for positional tracking of vehicle 12 within its operating environment E (which may be referred to as “localization”) and of any objects O within the operating environment E so that the position of such objects O with respect to vehicle 12 can be tracked and compared with the path 20 of trailer 14, as discussed above. By way of example, the use of camera 66 as a component of sensor system 16 in connection with avoidance routine 62 requires vehicle movement 12 for image processing of the data received from the camera 66 to function. Similarly, the vehicle radar units 78 require movement to track persistent points within the data received therefrom. As such, under the above-described functionality, trailer contact avoidance system 10 will not function according to the process described above immediately upon movement of vehicle 12 towing trailer 14 from a standstill until vehicle 12 travels a predetermined distance or moves for a period of time above a minimum threshold velocity v₁. Accordingly, the trailer contact avoidance system 10, as presently described, is configured to store vehicle 12 localization within the operating environment E, along with the various detected objects O therein, when vehicle 12 movement ends and through a resulting standstill, for use by system 10 upon a subsequent initiation of vehicle 12 movement. As discussed further herein, the use of stored data upon vehicle movement can be limited to certain situations where the stored data can reasonably be assumed to still be valid to maintain the usefulness and general reliability of the disclosed startup functionality. Additionally, certain aspects of the functionality described herein can be configured to improve system performance in certain scenarios involving vehicle movement after a standstill.

As can generally be appreciated a vehicle movement scenario can occur in two different general settings, one of which includes after an instance where the vehicle 12 is parked and turned “off” (as represented by the vehicle powertrain system 58 being turned from an “on” state, wherein the vehicle is running, to an “off” state, wherein the vehicle is not running). In general, such a condition, which may be referred to as a vehicle “startup”, corresponds with the “key” state of the vehicle, which can be represented by the turning position of a physical vehicle key or by the state of a pushbutton “ignition” system of the vehicle 12. In certain aspects, vehicle 12 may include functionality where the vehicle powertrain control system 56 stops the vehicle engine when vehicle 12 is stopped and automatically restarts the engine when vehicle 12 detects that a “launch” is intended, as long as the key or button state remains on. A vehicle equipped with such functionality, in addition to the implementation of system 10 described herein is considered to be in an “on” state based on the key or button condition, regardless of whether the engine is actually running or not, and will be considered “off” similarly depending on the key or button condition, such that the vehicle is off when the engine will not be restarted upon, for example, the user releasing the brake pedal. As can be appreciated, another startup condition corresponds with a vehicle “launch” after a standstill where the vehicle remains on, such as at a stop sign or during simple vehicle maneuvering.

In general, system 10 is configured to ensure that the localization of vehicle 12 (including the relative locations of any objects O within the operating environment E) is stored in memory 70 whenever a vehicle standstill is detected. In one aspect, controller 26 can detect a vehicle standstill by the vehicle 12 velocity v1 becoming zero, the vehicle parking brake 21 being engaged, the vehicle switchgear 60 being moved into “park”, or various combinations thereof. When controller 26 detects a standstill, controller 26 can store the localization data received from sensor system 16 for later access. As can be appreciated, various processes and schemes exist for what may generally be considered “storage” of the localization data, including but not limited to moving such data from volatile or temporary storage within memory 70 to persistent storage, implementing logic to designate the localization data as data for specific access upon detection of a startup or launch condition, or simply by taking steps to ensure that the data is not deleted or overwritten by subsequent actions or logic execution. In some instances, controller 26 may take different actions to store the localization data when controller 26 has determined that vehicle 12 has stopped and when the vehicle is turned off. In one example, controller 26 may refrain from or otherwise prevent the most recent localization data from being deleted or may specifically designate the data for use in a subsequent vehicle launch. In such an example, if the vehicle 12 is turned to the off state before such a launch takes place, controller 26 may move the localization data to persistent memory 70 as a part of the system shutdown process. Other schemes can be implemented for storage of localization data within the spirit of the disclosure. Additionally, the stored localization data can comprise the raw data received from sensor system 16 (including the “fused” data in certain implementations) or data processed by controller 26 or a processor within sensor system 16 to derive the specific location of vehicle 12 and any objects O within the operating environment O relative to vehicle 12.

In a vehicle startup scenario, system 10 is configured to implement certain limitations on the use of stored localization data and/or availability of the trailer contact avoidance system 10 depending on certain conditions developed to maintain acceptable or expected performance of the system. Such conditions, in particular, relate to maintaining certain valid assumptions, including that neither the vehicle 12 nor the trailer 14 have moved since the vehicle was turned off, that the trailer 14 was not disconnected from the vehicle 12 since the vehicle 12 was turned off, and that the operating environment O captured in the localization data has not significantly changed. To maintain these assumptions as valid, controller 26 can perform checks of system 10 when vehicle 12 is turned on. In one respect, controller 26 determines the time interval between “key cycles” (i.e., the vehicle being turned off and then turned on again). Controller 26 then compares this interval with a predetermined maximum time interval. Such maximum time interval can be calibrated to provide acceptable system 10 availability, while minimizing the likelihood that the operating environment has significantly changed. In one example, the time interval can correspond with what would generally be considered a “short” stop, such as between about 20 and 30 minutes. In another example, the time interval can allow for the vehicle 12 to be parked, for example, overnight at the owner's home, for example, up to about 24 hours. Other time limits are contemplated. Additionally, controller 26 can be configured to use variable time intervals depending on the location of vehicle 12 (e.g., up to a 48-hour limit when the positioning system 80 indicates that the vehicle 12 is parked at the owner's home or a 20-minute limit where the vehicle 12 is known to be parked at a busy location, such as a restaurant, shopping center, or the like) or the time of day (e.g., overnight, if parked after 8:00 P.M., or 30 minutes, if parked between 3:00 and 6:00 P.M.). Other examples are similarly contemplated.

If the time elapsed exceeds the limit, system 10 will not function. In such an instance, controller 26 can issue an indication 54 to the user (such as by a message displayed on the display 44 of HMI 42) that trailer contact avoidance system 10 is not operational and to proceed accordingly. In general, if the time elapsed between key cycles is less than the particular threshold used, system 10 will activate using the stored localization data as current localization data in an implementation of avoidance routine 62, as generally set out above. As noted above, certain components of the sensor system 16 can provide useable data when vehicle 12 is started at a standstill, including ultrasonic sensors 76. In an implementation, controller 26 can immediately update the localization data based on newly-acquired data from ultrasonic sensors 76. In particular, the ultrasonic sensors 76 can provide either updated data related to the position of any objects within a close distance to vehicle 12 or can be used to confirm that the operating environment E has not changed within the range of the ultrasonic sensors 76. Such functionality can improve the reliability of system 10 and, in some examples, can allow for a longer maximum cycle threshold.

In addition to the time threshold for system 10 availability, controller 26 can check the status of the trailer electrical connection 68 (by which trailer 14 draws power from vehicle 12 by coupling between connections). In one aspect, if no connection is detected, controller 26 can assume that the trailer 14 has been disconnected and make the system 10 functionality unavailable and issue an indication 54 to the user that the feature is unavailable. Additionally, some implementations of system 10 may include the ability to determine the identity of the trailer 14 through electrical connection 68 (either by the total resistive value or voltage drop across the trailer circuitry or by a designated identifying signal provided by the trailer electrical circuitry or the like). If a trailer 14 is detected that is different from the trailer 14 that was connected when the vehicle 12 was turned off, system 10 can similarly be made unavailable. In a further aspect, system 10 may be configured to allow the user to select a trailer profile from various profiles stored in memory 70 upon vehicle 12 startup, with such profile including trailer geometry information or the like useable by system 10. If the trailer profile selected varies from that which was active when vehicle 12 was turned off, system 10 can, again, be rendered temporarily unavailable. If the controller 26, thusly, determines that the trailer 14 has likely not been disconnected, controller 26 can run the trailer angle routine 74, discussed above, using one or more of a combination of camera 66 and/or ultrasonic sensors 76, to determine if the hitch angle γ is the same as that which was detected when vehicle 12 was previously stopped and turned off. To implement such functionality, in one example, controller 26 can store the trailer angle γ within the localization data. If the trailer angle is the same, system 10 may proceed as discussed above, with execution of the contact avoidance routine 62, as discussed above. If the trailer angle is different (within a preset tolerance, for example), controller 26 can render system 10 unavailable and can notify the user.

Additionally, as discussed above, controller 26 can be configured for desired performance of system 10 in executing contact avoidance routine 62 on a vehicle launch from a standstill condition. As discussed above, controller 26 can maintain localization data in memory 70 when vehicle 12 stops. In still further embodiments, controller 26 can maintain actively tracking the vehicle 12 localization an object O data when vehicle 12 comes to a standstill without being turned off, as the various components of sensor system 16 can remain active and properly calibrated. In this respect, controller 26 can continue to run the contact avoidance routine 62 using the stored data, updated data, or a combination thereof, while the vehicle 12 remains at a standstill, instead of inhibiting the contact avoidance routine 62. System 10 can continue to detect and track valid objects O within the operating environment E of vehicle 12. Notably, while the vehicle 12 remains at a standstill, system 10 may refrain from taking action in response to a determination that an object O presents a contact potential with respect to trailer 14 due to the fact that the position of the tracked objects or the steering angle δ may change before the vehicle standstill ends. Further, in some implementations, the controller 26 may assess a time to contact component as a part of the determination as to whether to present an indication message to the user or to intervene in the control of vehicle 12, which controller 26 would not necessarily be able to calculate with vehicle 12 at a standstill. It may be desirable, however, for controller 26 to be able to immediately notify the user, for example, when the vehicle 12 standstill ends, without a delay while vehicle 12 accelerates to a speed at which the time to contact may be appreciably calculated and/or without inducing the user to abruptly stop the vehicle immediately following an initial acceleration.

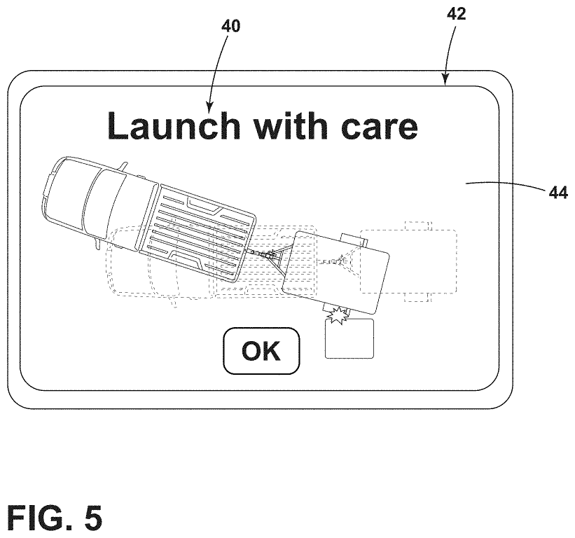

To accomplish the foregoing, controller 26 may be further configured to anticipate a vehicle 12 launch from standstill, which can be done by monitoring various vehicle systems or components for certain events. In one aspect, controller 26 can monitor the vehicle brake system 22 and the powertrain control system 58 to determine when one or both of the vehicle service brakes 21 or the parking brake 23 are released (i.e. changed from an active or engaged state to an inactive or released state) or when the switchgear 60 is moved into drive or reverse. Controller 26 can interpret these or other such events as indicating that the driver intends to launch the vehicle 12 and to begin acceleration to driving speeds. When such an intent is thusly detected, controller 26 can substitute the actual vehicle speed v1 (which is initially near zero and generally lower than the speed desired over even a short interval) for a pre-calibrated detection speed of, for example, between 1 and 3 mph (or in one embodiment about 1.25 mph) in the contact avoidance routine 62 discussed above. Notably, the use of the detection speed may represent the speed of the vehicle 12 after approximately the time-to-contact interval used in contact avoidance routine 62 to determine if a notification or intervention is warranted so that this time is not lost as vehicle 12 accelerates from the prior standstill and allows system 10 to provide a notification 40 (FIG. 5) to the driver of a potential trailer 14 contact with a nearby object O, as soon as the driver's intent to launch is indicated (i.e., immediately upon the driver releasing the service brakes 21) and, potentially, before appreciable acceleration is initiated.

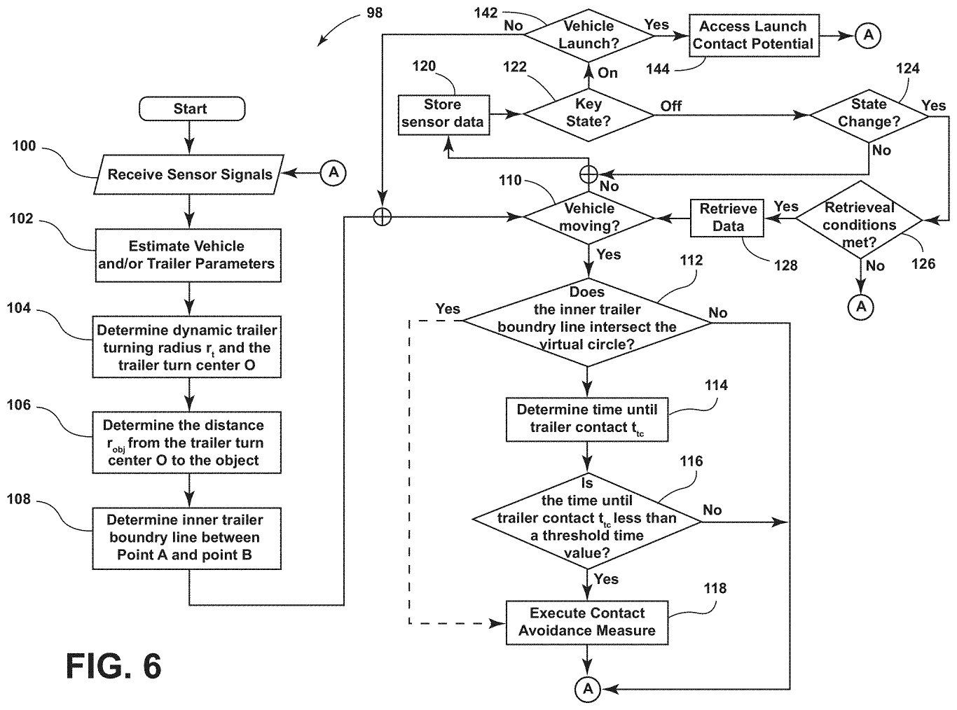

Referring now to FIG. 6, an embodiment of the trailer contact avoidance routine 62 for use in the trailer contact avoidance system 10 is illustrated. In the illustrated embodiment, the trailer contact avoidance routine 62 begins in step 100 on initial startup of the vehicle 12 and subsequent driving. In step 100, the controller 26 receives signals from the sensor system 16 of the vehicle 12. These signals may pertain to parameters and conditions relating to the vehicle 12, the trailer 14, and/or the object O. At step 102, when the data received in the signals indicates sufficient calibration, the data may be utilized to estimate various vehicle 12 and/or trailer 14 parameters. For example, in various examples, the received signals may be used to estimate the hitch angle γ, the trailer wheel base D, and the trailer width Tw. It is contemplated that in some examples, other vehicle 12 and/or trailer 14 parameters may additionally be estimated. At step 104, the trailer contact avoidance system 10 may determine the dynamic trailer turning radius rₜ and the trailer turn center O. Next, at step 106, the trailer contact avoidance system 10 may determine the distance r_{obj} from the trailer turn center O to the object O. At step 108, the trailer contact avoidance system 10 may determine the position of the inner trailer boundary line 90 extending between point A and point B. In various examples, the position of the inner trailer boundary line 90 is obtained by first determining point A and point B, as discussed in greater detail above.

Next, at step 110, the trailer contact avoidance system 10 monitors for continued movement of vehicle 12. As long as vehicle 12 remains moving, the system 10 functions normally, as discussed above, including by determining whether the inner trailer boundary line 90 intersects the virtual circle 92 having radius of r_{obj} (the distance of the detected object O from the trailer turning center O) and center (x_{c}, y_{c}) (the coordinates of the trailer turn center O) in step 112. If the inner trailer boundary line 90 does not intersect the virtual circle 92 then the trailer contact avoidance routine 62 may conclude or in some embodiments, return to step 100 to continuously update the sensor data and monitor for potential trailer contact. If the inner trailer boundary line 90 does intersect the virtual circle 92, then the trailer contact avoidance routine 98 may continue to step 114. However, as is illustrated by the dashed arrow in FIG. 6, in some examples, the trailer contact avoidance routine 98 may proceed directly to step 118 upon a determination that the inner trailer boundary line 90 does intersect the virtual circle 92, wherein the controller 26 of the trailer contact avoidance system 10 is configured to prompt one or more vehicle systems to execute the contact avoidance measure. In various embodiments, the trailer contact avoidance routine 98 proceeding directly to step 118 may be in addition to the trailer contact avoidance routine 98 proceeding to step 112 or as an alternative.

At step 114, the controller 26 of the trailer contact avoidance system 10 is configured to determine the time until contact t_{c} of the object O with the trailer 14. Next, at step 116, the trailer contact avoidance system 10 determines whether the time until contact tc is less than the threshold time value. If the time until contact t_{c} is not less than a threshold time value, the trailer contact avoidance routine 98 may return to the beginning of the routine and start again. If the time until contact t_{c} is less than a threshold time value, the trailer contact avoidance routine 98 may proceed to step 118, wherein the controller 26 of the trailer contact avoidance system 10 is configured to prompt one or more vehicle systems to execute the contact avoidance measure, as discussed in greater detail above.

If, in step 110, it is determined that the vehicle 12 is no longer moving (i.e., is at a standstill), the sensor data is stored in memory in step 120, as discussed above and key state of the vehicle 12 is checked (step 122) to determine if the vehicle 12 is still or has been turned off. If the vehicle 12 has been turned off the sensor data at the time of the standstill remains stored in memory while the vehicle 12 is off. Upon a subsequent restart of vehicle, determined by the key state of the vehicle changing (i.e., from off to on) in step 124, it is determined, in step 126, whether the conditions are met to use the stored sensor data to immediately proceed to step 112 and determine if a potential trailer contact is present and to continue with the routine, as discussed above. If conditions are not present to reliably retrieve the stored sensor data, the method returns to stop 100 to collect new sensor data and continues, as discussed above.

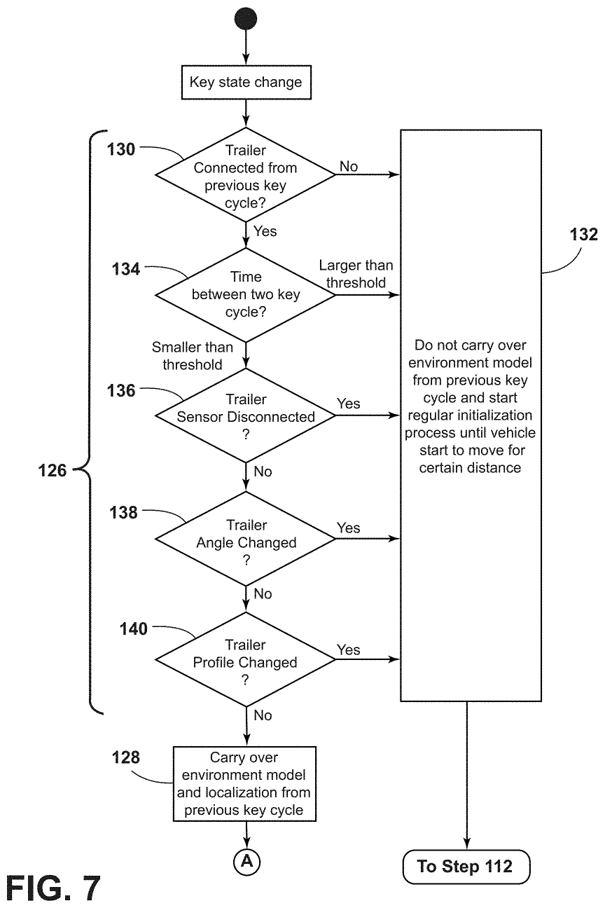

Turning to FIG. 7, the process carried out in step 126 to determine whether conditions are present that allow for retrieval of the stored sensor data is shown. As shown, the process involves checking various vehicle system and component states, as discussed above, to determine if the same trailer 14 is connected with vehicle 12 as when vehicle 12 was turned off and to the likelihood of a significant change to the operating environment E of vehicle 12. In the illustrated example, this includes checking (step) 130 to see if the trailer 12 is connected and if a connected trailer 12 is the same as the trailer that was previously connected. As discussed above, this can be done by checking the status of the trailer connection 68. If no trailer 14 or a different trailer 14 is connected with vehicle 14, then it is determined, in step 132, that the stored sensor data cannot be used and the method returns to step 100, as discussed above. If the same trailer 14 is connected, in step 130, the time interval between the vehicle 12 being turned off and being turned back on again is checked in step 134. If the interval is above a predetermined time interval, which may be variable or conditional, as discussed above, the stored data cannot be used (step 132), but if the time interval is within the threshold, the method proceeds with subsequent checks. In step 136, for example, if the previous trailer 14 included a trailer sensor module, a connection with the sensor module can be checked, with the process moving to step 132 if no connection can be found. In step 138, the trailer hitch angle γ can be checked (such as by controller 26 running the hitch angle detection routine 74 to determine if the current angle γ corresponds with the angle γ when vehicle 12 was turned off. If the angle γ is not the same, the stored data cannot be used (step 132). Subsequently, in a vehicle 12 that utilizes stored trailer profiles, the current profile can be checked against the active profile from when the vehicle 12 was turned off in step 140. If a different profile is selected, then the stored sensor data cannot be used and the process proceeds to step 132. If the trailer profile condition, and all other such conditions are met, then the stored sensor data can be used and is retrieved from memory (step 128) and the method proceeds, as discussed above.

Returning to FIG. 6, if vehicle 12 comes to a standstill (step 110) without being turned off (step 122), the vehicle 12 can maintain the current stored sensor data and, in step 142, monitor for a subsequent vehicle launch. As discussed above, when a vehicle launch is detected in step 142, the method can include using the sensor data and a detection threshold speed in substitute for the current (near-zero) vehicle velocity v1 in determining if a potential trailer 14 contact exists with respect to an adjacent object, as discussed above (step 144). If no potential contact is detected at launch, the system can move back to step 100 to continue to gather updated sensor data and to monitor for a potential trailer contact during continued driving.

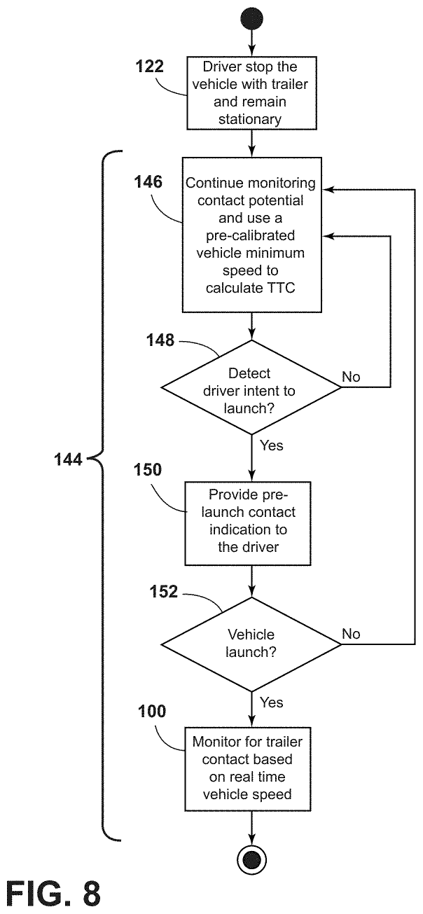

Turning to FIG. 8, the sub-process for assessing the potential for a trailer contact at launch in step 144. In particular, when the vehicle is at a standstill and remains on (step 122), the potential for contact between the trailer 14 and any nearby objects O is monitored using an alternative detection speed (e.g. 1.25 mph, as discussed above) in place of the zero or near-zero actual vehicle velocity v1. In connection with this determination, no intervention or notice is given to a detected potential contact while monitoring for an intent to end the standstill and launch the vehicle 12 (step 148). If a launch is detected, for example, from the driver releasing the vehicle service brakes 21 or the parking brake 23 or shifting the switchgear 60 into drive, an indication of a potential contact detected in step 146 may be issued (step 150). If no contact potential is detected, no waning is given. Subsequently, the method may proceed by monitoring to see if the vehicle actually launches (step 152) and begins moving (such as by the vehicle velocity v1 increasing or the vehicle wheels 28 beginning to turn). If the vehicle does not actually begin moving, the process returns to step 146 to monitor for a launch contact potential and a subsequent intent to launch. If the vehicle 12 does launch, the method continues normal monitoring using the actual vehicle velocity v1, such as by returning to step 100, as further depicted in FIG. 6.

The present disclosure may provide a variety of advantages. For example, operation of the trailer contact avoidance system 10 may enable the controller 26 to prompt the vehicle alert system 76 to execute an indication signal that may indicate to the driver of the vehicle 12 or other person that the object O detected by the sensor system 16 is in the travel path of the trailer 14 being towed by the vehicle 12, which may aid the driver in reacting to the situation. Further, in certain situations, operation of the trailer contact avoidance system 10 may enable the controller 26 to prompt various other vehicle systems, such as the power assist steering system 62, to actively adjust the steering angle δ of the vehicle 12 in response to a determination that the object O is in the travel path of trailer 14 and/or that the time until contact t_{c} is less than a predetermined threshold time value, which may allow for avoidance of a contact event.

It is to be understood that variations and modifications can be made on the aforementioned structure without departing from the concepts of the present disclosure, and further it is to be understood that such concepts are intended to be covered by the following claims unless these claims by their language expressly state otherwise.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A trailer flank object contact avoidance system for a vehicle towing a trailer, comprising:
a sensor system configured to detect objects in an operating environment of the vehicle; and
a controller configured to:
process information received from the sensor system to monitor a relative position of at least one object with respect to the vehicle during an initial vehicle movement;
store in memory the information received from the sensor system as a reference data set at an instance when the initial vehicle movement ends at a vehicle standstill; and
retrieve from memory the reference data set upon detecting an event indicating an end of the vehicle standstill relating to a subsequent vehicle movement, process the reference data set to determine whether the at least one object is in a travel path of the trailer corresponding with the subsequent vehicle movement, and execute a contact avoidance measure based on the at least one object being in the travel path of the trailer.

2. The system of claim 1, wherein the controller is further configured to:
determine that the standstill is associated with the vehicle parked and in an off condition; and
only retrieve from memory the reference data set and process the information received from the sensor system to determine whether the at least one object is in the travel path of the trailer if the event indicating the end of the vehicle standstill is detected at an elapsed time from the end of the initial vehicle movement being within a predetermined time interval.

3. The system of claim 2, wherein the controller is further configured to communicate a feature unavailable status if the elapsed time exceeds the predetermined time interval.

4. The system of claim 1, wherein the controller is further configured to:
determine that the standstill is associated with the vehicle being parked and in an off condition;
detect a trailer movement event; and
only retrieve from memory the reference data set and process the information received from the sensor system to determine whether the at least one object is in a travel path of the trailer if the event indicating the end of the vehicle standstill is detected within a predetermined time interval of the end of the initial vehicle movement and if the controller has not detected the trailer movement event.

5. The system of claim 4, wherein:
the controller is further configured to detect a trailer electrical connection status with respect to a vehicle electrical connection and a trailer hitch angle with respect to the vehicle and to receive a trailer profile selection from a user; and
the trailer movement event is detected by one of:
the trailer electrical connection status changing to a connected status the vehicle standstill;
the trailer electrical connection status changing to a disconnected status during the vehicle standstill;
the trailer hitch angle having different values at the end of the vehicle standstill and the end of the initial vehicle movement; or
the controller receiving the trailer profile selection during the standstill.

6. The system of claim 4, wherein the controller is further configured to communicate a feature unavailable status if either the event indicating the end of the vehicle standstill is detected outside of the predetermined time interval of the end of the initial vehicle movement or the trailer movement event is detected.

7. The system of claim 1, wherein:
the sensor system includes an ultrasonic sensor, a radar unit, and a camera, the relative position of the at least one object being stored as combined data from the ultrasonic sensor, the radar unit, and the camera; and
the controller is configured to process the reference data set retrieved from memory associated with the radar unit and the camera in combination with new information received from the ultrasonic sensor to determine whether the at least one object is in a travel path of the trailer corresponding with the subsequent vehicle movement.

8. The system of claim 1, wherein:
the controller is further configured to detect at least one of a vehicle service brake position, a vehicle parking brake status, or a vehicle switchgear state; and
the controller detects the event indicating the end of the vehicle standstill based on at least one of:
the vehicle service brake position indicating a release of the vehicle service brakes;
the vehicle parking brake status indicating a release of the vehicle parking brake; or
the vehicle switchgear state indicating shifting of the switchgear into a drive state or a reverse state.

9. The system of claim 1, wherein the controller uses an assumed vehicle speed when processing the reference data set.

10. The system of claim 1, wherein the reference data set includes the relative position of the at least one object and a localized vehicle position.

11. The system of claim 1, wherein the contact avoidance measure comprises at least one of:
reducing a manual steering torque assist supplied by a power assist steering system;
executing an indication signal via a vehicle alert system; and
causing a reduction in a speed of the vehicle.

12. A trailer flank object contact avoidance system for a vehicle towing a trailer, comprising:
a sensor system configured to detect objects in an operating environment of the vehicle; and
a controller configured to:
process information received from the sensor system to monitor a relative position of at least one object with respect to the vehicle during an initial vehicle movement;
determine when the initial vehicle movement ends at a vehicle standstill;
monitor for an event indicating an intent to launch the vehicle from the vehicle standstill; and
process the reference data set to determine whether the at least one object is in a travel path of the trailer corresponding with a subsequent vehicle movement resulting from the intent to launch the vehicle, and to execute a contact avoidance measure based the at least one object being in the travel path of the trailer.

13. The system of claim 12, wherein the controller uses an assumed vehicle speed when processing the reference data set.

14. The system of claim 13, wherein the controller is further configured to:
determine that the vehicle has launched in response to the event indicating the intent to launch the vehicle from the vehicle standstill; and
continue processing the reference data set using a measured vehicle speed to determine whether the at least one object is in the travel path of the trailer during the subsequent vehicle movement resulting from the intent to launch the vehicle.

15. The system of claim 12, wherein:
the controller is further configured to detect at least one of a vehicle service brake position, a vehicle parking brake status, or a vehicle switchgear state; and
the event indicating the intent to launch the vehicle from the vehicle standstill is at least one of:
the vehicle service brake position indicating a release of the vehicle service brakes;
the vehicle parking brake status indicating a release of the vehicle parking brake; or
the vehicle switchgear state indicating shifting of the switchgear into a drive state or a reverse state.

16. A trailer flank object contact avoidance system for a vehicle towing a trailer, comprising:
a sensor system configured to detect objects in an operating environment of the vehicle; and
a controller configured to:
process information received from the sensor system to monitor a relative position of at least one object with respect to the vehicle during an initial vehicle movement;
store in memory the information received from the sensor system as a reference data set at an instance when the initial vehicle movement ends at a vehicle standstill and to maintain the information in memory in response to the vehicle being turned off; and
retrieve from memory the reference data set upon the vehicle subsequently being turned on, process the reference data set, upon a subsequent vehicle movement, to determine whether the at least one object is in a travel path of the trailer corresponding with the subsequent vehicle movement, and to execute a contact avoidance measure based on the at least one object being in the travel path of the trailer.

17. The system of claim 16, wherein the controller is further configured to only retrieve from memory the reference data set and process the information received from the sensor system to determine whether the at least one object is in the travel path of the trailer upon the vehicle being subsequently turned on at an elapsed time from the vehicle being turned off within a predetermined time interval.

18. The system of claim 17, wherein the controller is further configured to communicate a feature unavailable status if the elapsed time exceeds the predetermined time interval.

19. The system of claim 17, wherein the controller is further configured to:
detect a trailer movement event; and
only retrieve from memory the reference data set and process the information received from the sensor system to determine whether the at least one object is in the travel path of the trailer, if the controller has not detected the trailer movement event.

20. The system of claim 19, wherein the controller is further configured to detect a trailer electrical connection status with respect to a vehicle electrical connection and a trailer hitch angle with respect to the vehicle and to receive a trailer profile selection from a user; and
the trailer movement event is detected by one of:
the trailer electrical connection status changing to a connected status the vehicle standstill;
the trailer electrical connection status changing to a disconnected status during the vehicle standstill;
the trailer hitch angle having different values at the end of the vehicle standstill and the end of the initial vehicle movement; or
the controller receiving the trailer profile selection during the standstill.
